(19) United States
(12) Patent Application Publication
(10) Pub. No.: US 2015/0209939 A1
(43) Pub. Date: Jul. 30, 2015

(54) Adjustable Positioning Fixture

(71) Applicant: Ho Chi-Fu, Taichung (TW)

(72) Inventor: Ho Chi-Fu, Taichung (TW)

(21) Appl. No.: 14/165,907

(22) Filed: Jan. 28, 2014

(51) Int. Cl. B25B 5/00

(52) U.S. Cl. CPC B25B 5/003

(57) ABSTRACT

An adjustable positioning fixture contains: a first adjusting arm, a second adjusting arm, a first clamper, and a second clamper. The first adjusting arm includes a first abutting portion for contacting with a first workpiece. The second adjusting arm including a second abutting portion for contacting with a second workpiece, and a rotatable fixing structure is defined between the first adjusting arm and the second adjusting arm so as to adjust a rotating angle between the first adjusting arm and the second adjusting arm. The first clamper includes a first clamping jaw and a second clamping jaw for clamping the first adjusting arm and the first workpiece. The second clamper includes a third clamping jaw and a fourth clamping jaw for clamping the second adjusting arm and the second workpiece.

### FIELD OF THE INVENTION

The present invention relates to a display box for sockets which prevents the sockets from being stolen and enhances aesthetics appearance.

### BACKGROUND OF THE INVENTION

Referring to FIG. 1, a conventional positioning fixture 10 contains a first adjusting block 11, a second adjusting block 12, a first clamper 13, and a second clamper 14. The first adjusting block 11 includes a first abutting face 111 and a first connecting disc 112, the second adjusting block 12 includes a second abutting face 121 and a second connecting disc 122, the first connecting disc 112 and the second connecting disc 122 has a positioning member 15 so as to adjustably position a rotating angle between the first adjusting block 11 and the second adjusting block 12. The first clamper 13 includes a first clamping jaw 131 disposed on a first end portion thereof and a first screwing bolt 16 mounted on a second end portion thereof so as to screw with the first adjusting block 11. The second clamper 14 includes a second clamping jaw 141 disposed on a first end portion thereof and a second screwing bolt 17 mounted on a second end portion thereof so as to screw with the second adjusting block 12. As connecting a first workpiece 20 with a second workpiece 20a, the first abutting face 111 of the first adjusting block 11 contacts with the first workpiece 20, and the second abutting face 121 of the second adjusting block 12 contacts with the second workpiece 20a, such that the first clamper 13 and the second clamper 14 clamp the first workpiece 20 and the second workpiece 20a, and the rotating angle between the first adjusting block 11 and the second adjusting block 12 are adjusted, the positioning member 15 positions the first adjusting block 11 and the second adjusting block 12, and the first workpiece 20 and the second workpiece 20a are fixed at a connection angle so as to connect the first workpiece 20 with the second workpiece 20a (such as welding the first workpiece 20 with the second workpiece 20a). However, the conventional positioning fixture 10 still has the following defects:

1. As shown in FIGS. 1 and 2, after the first workpiece 20 and the second workpiece 20a are fixed, if the first workpiece 20 and the second workpiece 20a are connected at a first coupling position, the first connecting disc 112 of the first adjusting block 11, the second disc 122 of the second adjusting block 12, and the positioning member 15 will interfere an connecting process. Taking a welding process for example, a non-interference area of the first workpiece 20 and the second workpiece 20a is welded firstly, and then the positioning fixture 10 is removed to have a second-time welding process, thus having welding process troublesomely.

2. As illustrated in FIGS. 1 and 3, the first adjusting block 11, the second adjusting block 12, the first clamper 13, and the second clamper 14 clamp the first workpiece 20 and the second workpiece 20a reversely. But because the first clamper 13 is screwed with the first adjusting block 11 by means of the first screwing bolt 16, and the second clamper 14 is screwed with the second adjusting block 12 by means of the second screwing bolt 17, when adjusting the connection angle between the first workpiece 20 and the second workpiece 20a, the first clamper 13 and the second clamper 14 interfere with each other.

3. Due to the first clamper 13 is screwed with the first adjusting block 11 by means of the first screwing bolt 16, and the second clamper 14 is screwed with the second adjusting block 12 by means of the second screwing bolt 17, if the first clamper 13 and the second clamper 14 are applied as a clamp tool, the first screwing bolt 16 and the second screwing bolt 17 are removed firstly, and then a third clamping jaw and a fourth clamping jaw are mounted on the first clamper 13 and the second clamper 14, so the conventional positioning fixture 10 is employed as the clamp tool inconveniently.

The present invention has arisen to mitigate and/or obviate the afore-described disadvantages.

### SUMMARY OF THE INVENTION

The primary object of the present invention is to provide an adjustable positioning fixture in which a first clamper and a second clamper are moved to connect a first workpiece and a second workpiece together.

Further object of the present invention is to provide an adjustable positioning fixture which expands an angle adjusting range of a first adjusting arm and a second adjusting arm by moving the first clamper and the second clamper so as to connect a first workpiece with a second workpiece easily.

Another object of the present invention is to provide an adjustable positioning fixture which after a first clamping jaw of the first clamper removes from a first sliding slot of the first adjusting arm or a second clamping jaw of the second clamper removes from a second sliding slot of the second adjusting arm, the first clamper and the second clamper can be used as a clamp tool.

To obtain the above objectives, an adjustable positioning fixture provided by the present invention contains:

a first adjusting arm including a first abutting portion disposed on a first side thereof so as to contact with a first workpiece;

a second adjusting arm including a second abutting portion disposed on a first side thereof so as to contact with a second workpiece, and a rotatable fixing structure being defined between the first adjusting arm and the second adjusting arm so as to adjust a rotating angle between the first adjusting arm and the second adjusting arm;

a first clamper including a first clamping jaw mounted on an end portion of a first lower end thereof and a second clamping jaw fixed on an end portion of a second lower end thereof so as to clamp the first adjusting arm and the first workpiece;

a second clamper including a third clamping jaw mounted on an end portion of a third lower end thereof and a fourth clamping jaw fixed on an end portion of a fourth lower end thereof so as to clamp the second adjusting arm and the second workpiece.

Also, an adjustable positioning fixture provided by the present invention contains:

a first adjusting arm including a first abutting portion disposed on a first side thereof so as to contact with a first workpiece and a first sliding slot defined on a second side thereof;

a second adjusting arm including a second abutting portion disposed on a first side thereof so as to contact with a second workpiece and a second sliding slot defined on a second side thereof, and a rotatable fixing structure being defined between the first adjusting arm and the second adjusting arm so as to adjust a rotating angle between the first adjusting arm and the second adjusting arm;

a first clamper including a first clamping jaw mounted on an end portion of a first lower end thereof and a second clamping jaw fixed on an end portion of a second lower end thereof so as to clamp the first adjusting arm and the first workpiece, wherein the first clamping jaw or the second clamping jaw of the first clamper is slidably secured in the first sliding slot of the first adjusting arm;

a second clamper including a third clamping jaw mounted on an end portion of a third lower end thereof and a fourth clamping jaw fixed on an end portion of a fourth lower end thereof so as to clamp the second adjusting arm and the second workpiece, wherein the third clamping jaw or the fourth clamping jaw of the second clamper is slidably secured in the second sliding slot of the second adjusting arm.

### BRIEF DESCRIPTION OF THE DRAWINGS

FIG. 1 is a perspective view showing the operation of a conventional positioning fixture.

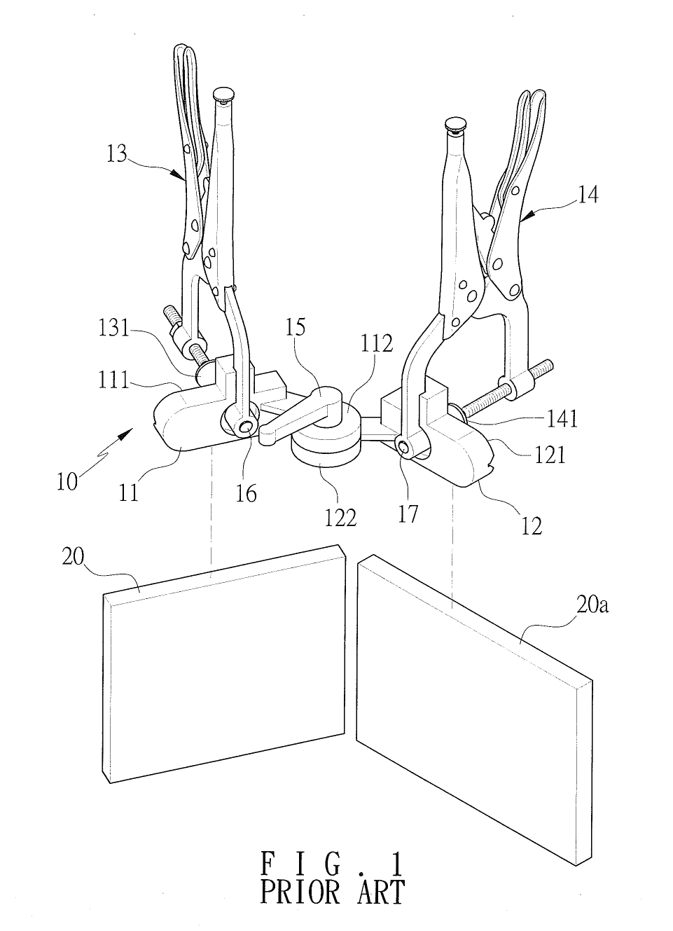

FIG. 2 is a plan view showing the operation of the conventional positioning fixture.

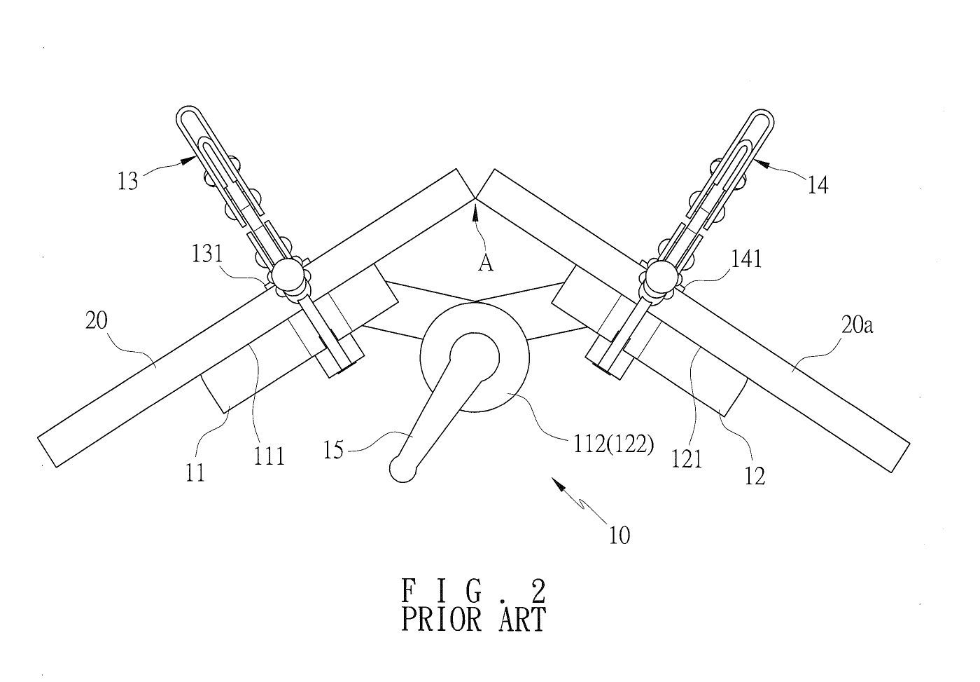

FIG. 3 is anther plan view showing the operation of the conventional positioning fixture.

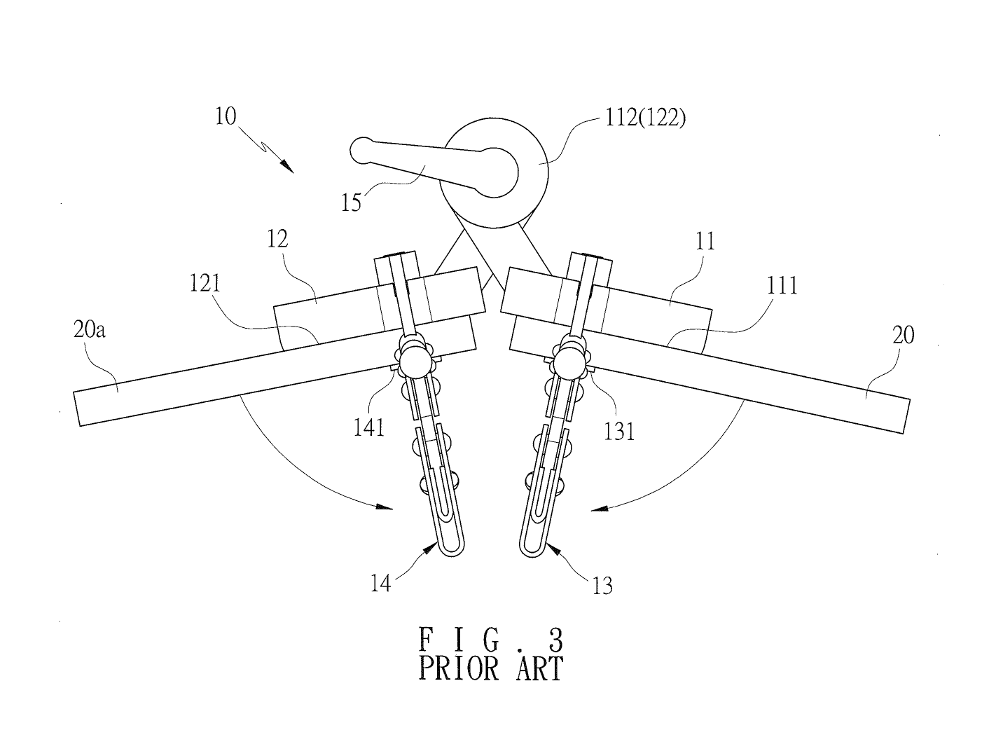

FIG. 4 is a perspective view showing the exploded components of an adjustable positioning fixture according to a first embodiment of the present invention.

FIG. 5 is a perspective view showing the assembly of the adjustable positioning fixture according to the first embodiment of the present invention.

FIG. 6 is a plan view showing the assembly of the adjustable positioning fixture according to the first embodiment of the present invention.

FIG. 7 is another plan view showing the assembly of the adjustable positioning fixture according to the first embodiment of the present invention.

FIG. 8 is also another plan view showing the assembly of the adjustable positioning fixture according to the first embodiment of the present invention.

FIG. 9 is still another plan view showing the assembly of the adjustable positioning fixture according to the first embodiment of the present invention

FIG. 10 is a perspective view showing the exploded components of an adjustable positioning fixture according to a second embodiment of the present invention.

FIG. 11 is a perspective view showing the assembly of the adjustable positioning fixture according to the second embodiment of the present invention.

### DETAILED DESCRIPTION OF THE PREFERRED EMBODIMENTS

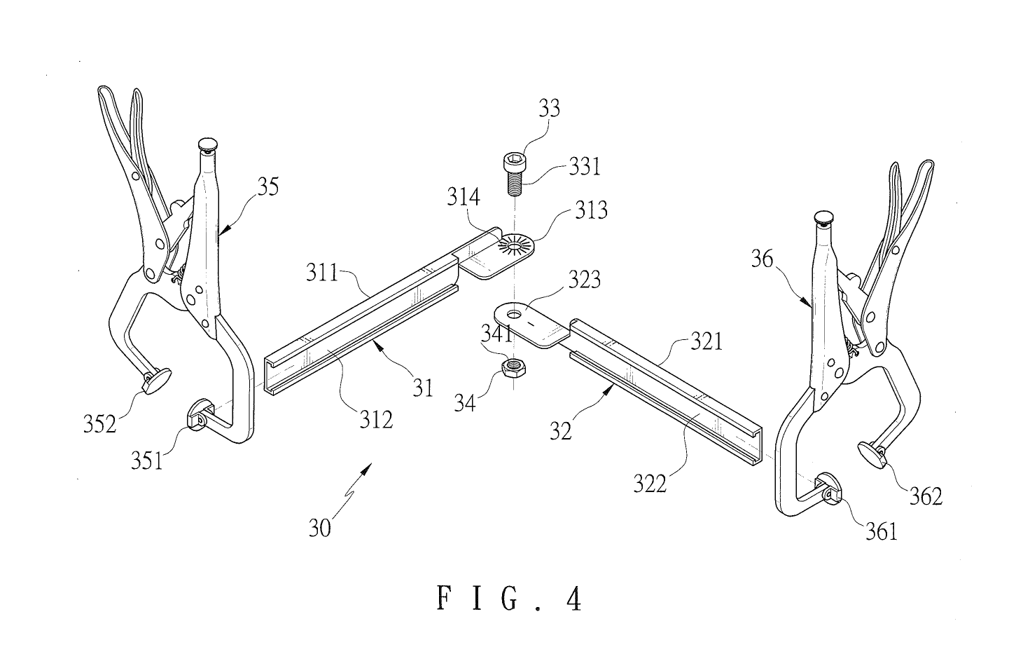

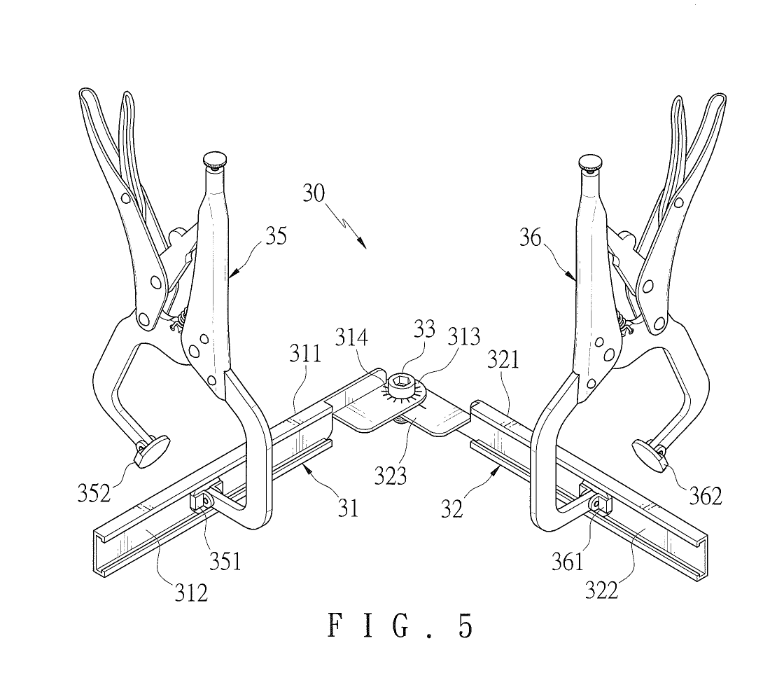

With reference to FIGS. 4 and 5, an adjustable positioning fixture 30 according to a first embodiment of the present invention comprises: a first adjusting arm 31, a second adjusting arm 32, a first clamper 35, and a second clamper 36.

The first adjusting arm 31 includes a first abutting portion 311 disposed on a first side thereof so as to contact with a first workpiece and includes a first sliding slot 312 defined on a second side thereof and having a first shoulder; the second adjusting arm 32 includes a second abutting portion 321 disposed on a first side thereof so as to contact with a second workpiece and includes a second sliding slot 322 defined on a second side thereof and having a second shoulder, and a rotatable fixing structure is defined between the first adjusting arm 31 and the second adjusting arm 32 so as to adjust a rotating angle between the first adjusting arm 31 and the second adjusting arm 32. In this embodiment, the rotatable fixing structure includes a first connecting segment 313 mounted on an end portion of the first adjusting arm 31 and having a first hole, a second connecting segment 323 mounted on an end portion of the second adjusting arm 32 and having a second hole, a bolt element 33 inserted through the first connecting segment 313 of the first adjusting arm 31 and the second connecting segment 323 of the second adjusting arm 32 and having an threaded extension 331, and a screwing element 34 having inner threads 341 for screwing with the threaded extension 331 of the bolt element 33, such that the first adjusting arm 31 and the second adjusting arm 32 adjust the rotating angle along the bolt element 33, and then the first adjusting arm 31 and the second adjusting arm 32 are locked by ways of the screwing element 34 and the bolt element 33 so as to position the rotating angle; wherein the screwing element 34 is welded on the second connecting segment 323 of the second adjusting arm 32 so as to adjust the rotating angle between the first adjusting arm 31 and the second adjusting arm 32. To adjust the rotating angle between the first adjusting arm 31 and the second adjusting arm 32, a graduation indicator 314 arranged on the first connecting segment 313 of the first adjusting arm 31 so as to view the rotating angle between the first adjusting arm 31 and the second adjusting arm 32. The first clamper 35 includes a first clamping jaw 351 mounted on an end portion of a first lower end thereof and a second clamping jaw 352 fixed on an end portion of a second lower end thereof so as to clamp the first adjusting arm 31 and the first workpiece, and wherein the first clamping jaw 351 or the second clamping jaw 352 of the first clamper 35 is slidably secured in the first sliding slot 312 of the first adjusting arm 31 so as to movably adjust a first clamping position of the first clamper 351 and the second clamper 352. In this embodiment, the first clamping jaw 351 of the first clamper 35 is slidably secured in the first sliding slot 312 of the first adjusting arm 31. The second clamper 36 includes a third clamping jaw 361 mounted on an end portion of a third lower end thereof and a fourth clamping jaw 362 fixed on an end portion of a fourth lower end thereof so as to clamp the second adjusting arm 32 and the second workpiece, and wherein the third clamping jaw 361 or the fourth clamping jaw 362 of the second clamper 36 is slidably secured in the second sliding slot 322 of the second adjusting arm 32 so as to movably adjust a second clamping position of the third clamper 361 and the fourth clamper 362. In this embodiment, the third clamping jaw 361 of the first clamper 36 is slidably secured in the second sliding slot 322 of the second adjusting arm 32. Since the first clamper 35 and the second clamper 36 is well-known art, further remarks are omitted. After the first clamping jaw 351 of the first clamper 35 removes from the first sliding slot 312 of the first adjusting arm 31 or the second clamping jaw 361 of the second clamper 36 removes from the second sliding slot 322 of the second adjusting arm 32, the first clamper 35 and the second clamper 36 are used as a clamp tool.

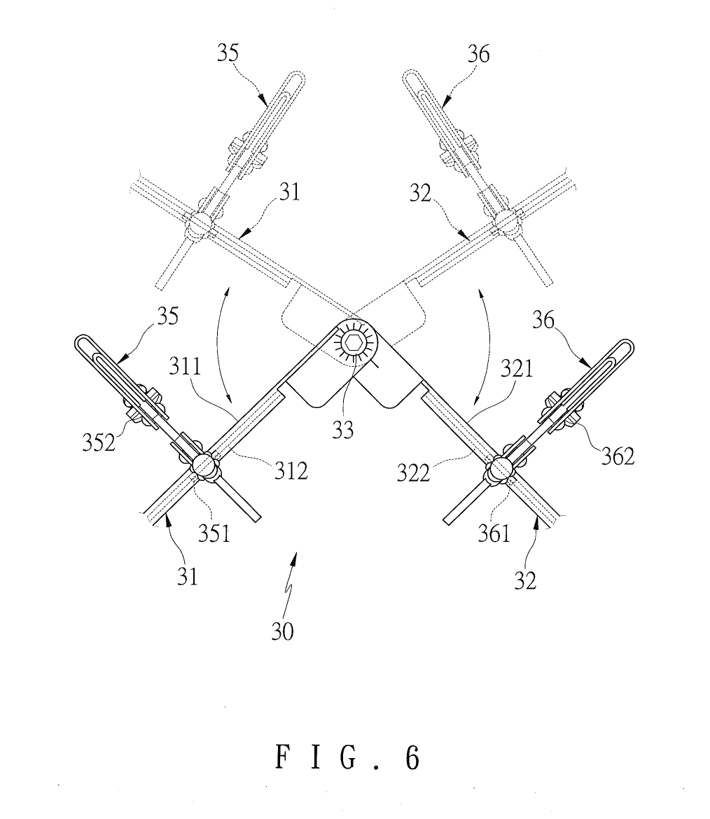

Referring to FIG. 6, the adjustable positioning fixture 30 is positioned at desired angles after the first adjusting arm 31 and the second adjusting arm 32 are adjusted and fixed, and the first abutting portion 311 of the first adjusting arm 31 and the second abutting portion 321 of the second adjusting arm 32 contact with the first workpiece and the second workpiece so that the first clamper 35 and the second clamper 36 clamp the first workpiece and the second workpiece, thus fixing a connecting angle of the first workpiece and the second workpiece. When desiring to adjust the connecting angle, the first clamper 35 moves along the first sliding slot 312 of the first adjusting arm 31 to adjust so as to movably adjust the second clamping position of the third clamper 361 and the fourth clamper 362, thereby increasing angle adjusting range of the first adjusting arm 31 and the second adjusting arm 32,

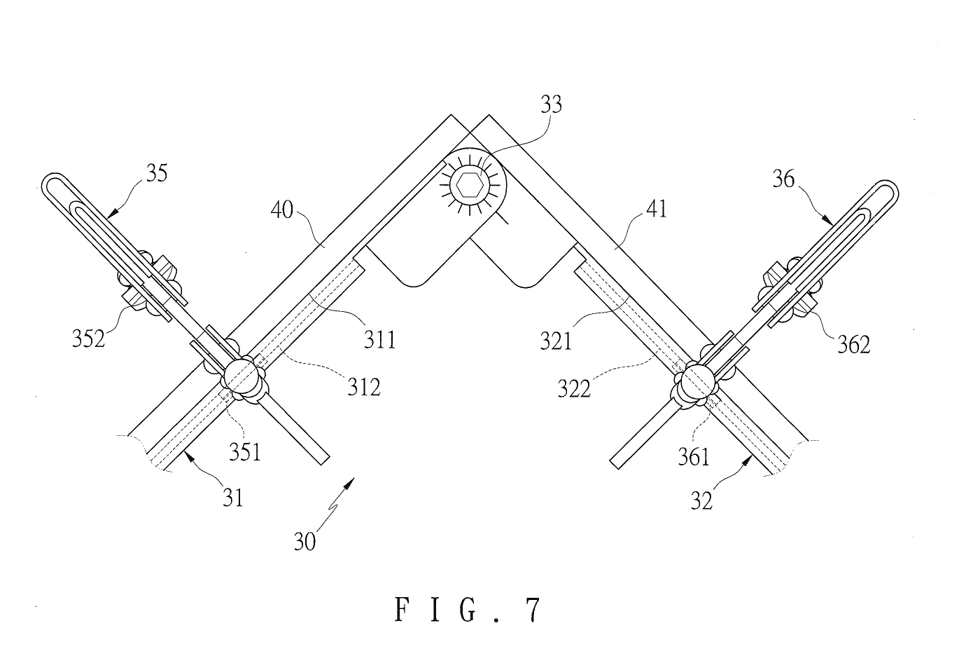

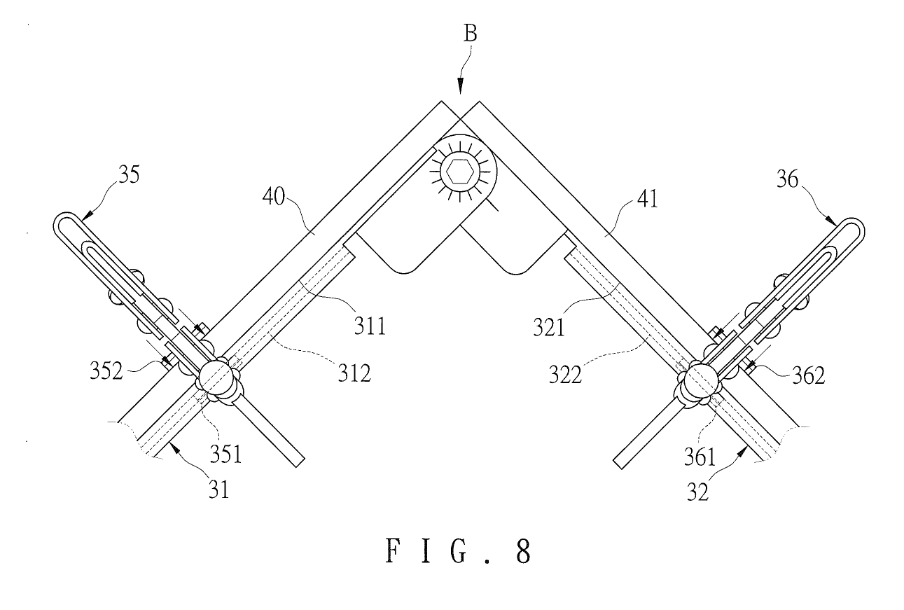

As shown in FIG. 7, in operation, the first adjusting arm 31 and the second adjusting arm 32 are adjusted along the bolt element 33 so as to adjust the rotating angle between the first adjusting arm 31 and the second adjusting arm 32, and then the first abutting portion 311 of the first adjusting arm 31 contact with the first workpiece, the second abutting portion 321 of the second adjusting arm 32 contacts with the second workpiece. In this embodiment, an inner surface of the first workpiece 40 contacts with the first abutting portion 311 of the first adjusting arm 31, an inner surface of the second workpiece 41 contacts with the second abutting portion 321 of the second adjusting arm 32. As illustrated in FIG. 8, the first clamping jaw 351 and the second clamping jaw 352 of the first clamper 35 clamp the first adjusting arm 31 and the first workpiece 40, the third clamping jaw 361 and the fourth clamping jaw 362 of the second clamper 36 clamp the second adjusting arm 32 and the second workpiece 41, so that the first workpiece 40 and the second workpiece 41 are positioned at the connecting angle of the first workpiece 40 and the second workpiece 41, thus welding or screwing an outer surface of the first workpiece 40 with an outer surface of the second workpiece 41 at a first connection position B.

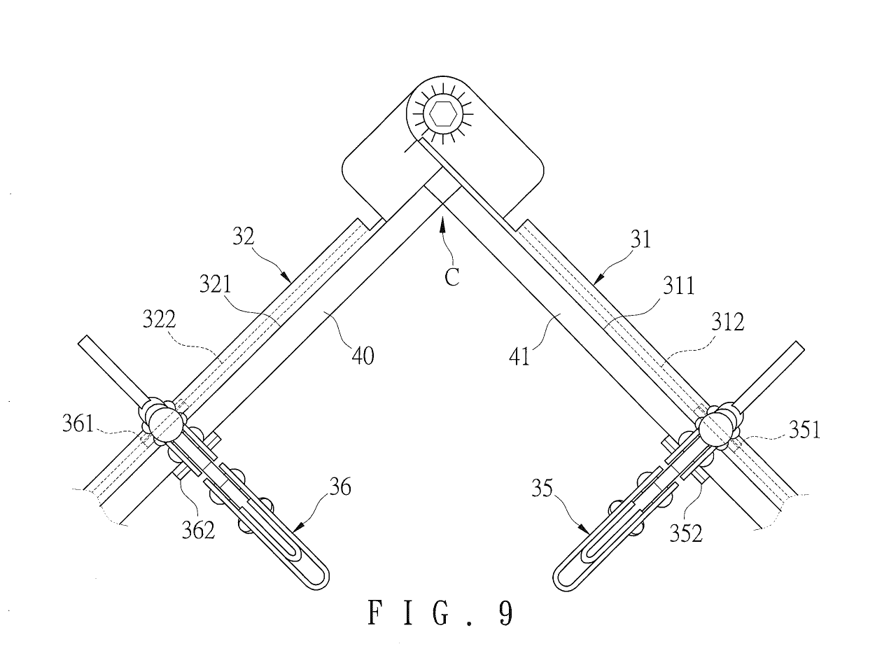

With reference to FIG. 9, as desiring to connect the outer surface of the first workpiece 40 with the outer surface of the second workpiece 41 at a second connection position C, the first adjusting arm 31 and the second adjusting arm 32 are rotated so that the outer surface of the first workpiece 40 contacts with the first abutting portion 311 of the first adjusting arm 31, the outer surface of the second workpiece 41 contacts with the second abutting portion 321 of the second adjusting arm 32, the first clamping jaw 351 and the second clamping jaw 352 of the first clamper 35 clamp the first adjusting arm 31 and the first workpiece 40, the third clamping jaw 361 and the fourth clamping jaw 362 of the second clamper 36 clamp the second adjusting arm 32 and the second workpiece 41, and the first clamper 35 is moved along the first sliding slot 312 of the first adjusting arm 31 so as to movably adjust the first clamping position of the first clamper 351 and the second clamper 352, the second clamper 36 is moved along the second sliding slot 322 of the first adjusting arm 32 so as to movably adjust the second clamping position of the third clamper 361 and the fourth clamper 362, thus avoiding the first clamper 35 interference with the second clamper 36. In addition, the first workpiece 40 and the second workpiece 41 are fixed at the connecting angle so as to connect the first workpiece 40 with the second workpiece 41 at the second connection position C. Thereby, the adjustable positioning fixture expands the angle adjusting range of the first adjusting arm and the second adjusting arm by moving the first clamper and the second clamper so as to connect the first workpiece with the second workpiece easily.

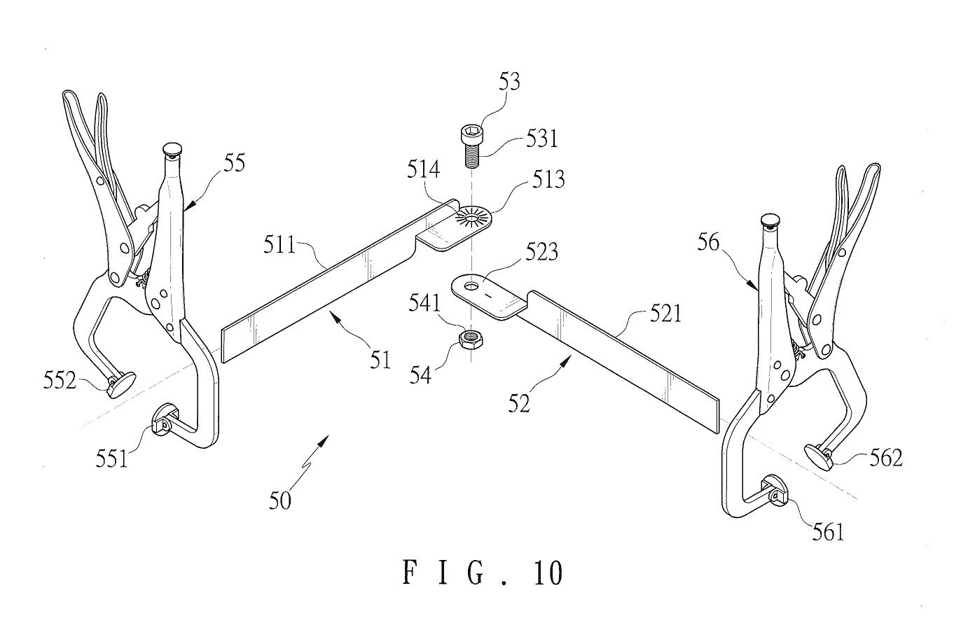

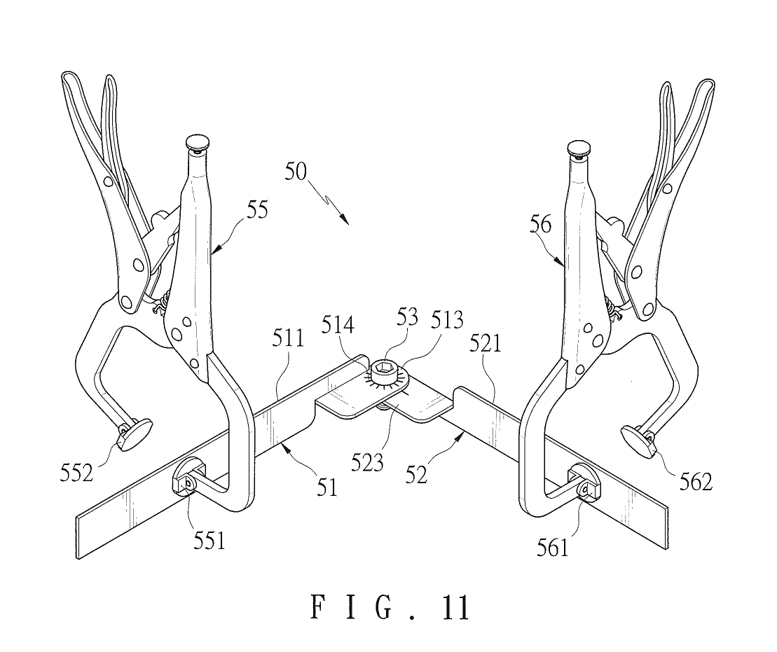

With reference to FIGS. 10 and 11, an adjustable positioning fixture 50 according to a second embodiment of the present invention comprises: a first adjusting arm 51, a second adjusting arm 52, a first clamper 55, and a second clamper 56.

The first adjusting arm 51 includes a first abutting portion 511 disposed on a first side thereof so as to contact with a first workpiece; the second adjusting arm 52 includes a second abutting portion 521 disposed on a first side thereof so as to contact with a second workpiece; and a rotatable fixing structure is defined between the first adjusting arm 51 and the second adjusting arm 52 so as to adjust a rotating angle between the first adjusting arm 51 and the second adjusting arm 52. In this embodiment, the rotatable fixing structure includes a first connecting segment 513 mounted on an end portion of the first adjusting arm 51 and having a first hole, a second connecting segment 523 mounted on an end portion of the second adjusting arm 52 and having a second hole, a bolt element 53 inserted through the first connecting segment 513 of the first adjusting arm 51 and the second connecting segment 523 of the second adjusting arm 52 and having an threaded extension 531, and a screwing element 54 having inner threads 541 for screwing with the threaded extension 531 of the bolt element 53, such that the first adjusting arm 51 and the second adjusting arm 52 adjust the rotating angle along the bolt element 53, and then the first adjusting arm 51 and the second adjusting arm 52 are locked by ways of the screwing element 54 and the bolt element 53 so as to position the rotating angle. To adjust the rotating angle between the first adjusting arm 51 and the second adjusting arm 52, a graduation indicator 514 arranged on the first connecting segment 513 of the first adjusting arm 51 so as to view the rotating angle between the first adjusting arm 51 and the second adjusting arm 52. The first clamper 55 includes a first clamping jaw 551 mounted on an end portion of a first lower end thereof and a second clamping jaw 552 fixed on an end portion of a second lower end thereof so as to clamp the first adjusting arm 51 and the first workpiece. The second clamper 56 includes a third clamping jaw 561 mounted on an end portion of a third lower end thereof and a fourth clamping jaw 562 fixed on an end portion of a fourth lower end thereof so as to clamp the second adjusting arm 52 and the second workpiece, hence the adjustable positioning fixture 50 is used to connect the first workpiece and the second workpiece together by moving the first clamper 55 and the second clamper 56. Also, the adjustable positioning fixture can expand an angle adjusting range of the first adjusting arm and the second adjusting arm by moving the first clamper and the second clamper so as to connect the first workpiece with the second workpiece easily.

While the preferred embodiments of the invention have been set forth for the purpose of disclosure, modifications of the disclosed embodiments of the invention as well as other embodiments thereof may occur to those skilled in the art.

Accordingly, the appended claims are intended to cover all embodiments which do not depart from the spirit and scope of the invention.

What is claimed is:

1. An adjustable positioning fixture comprising:
a first adjusting arm including a first abutting portion disposed on a first side thereof so as to contact with a first workpiece;
a second adjusting arm including a second abutting portion disposed on a first side thereof so as to contact with a second workpiece, and a rotatable fixing structure being defined between the first adjusting arm and the second adjusting arm so as to adjust a rotating angle between the first adjusting arm and the second adjusting arm;
a first clamper including a first clamping jaw mounted on an end portion of a first lower end thereof and a second clamping jaw fixed on an end portion of a second lower end thereof so as to clamp the first adjusting arm and the first workpiece;
a second clamper including a third clamping jaw mounted on an end portion of a third lower end thereof and a fourth clamping jaw fixed on an end portion of a fourth lower end thereof so as to clamp the second adjusting arm and the second workpiece.

2. An adjustable positioning fixture comprising:
a first adjusting arm including a first abutting portion disposed on a first side thereof so as to contact with a first workpiece and a first sliding slot defined on a second side thereof;
a second adjusting arm including a second abutting portion disposed on a first side thereof so as to contact with a second workpiece and a second sliding slot defined on a second side thereof, and a rotatable fixing structure being defined between the first adjusting arm and the second adjusting arm so as to adjust a rotating angle between the first adjusting arm and the second adjusting arm;
a first clamper including a first clamping jaw mounted on an end portion of a first lower end thereof and a second clamping jaw fixed on an end portion of a second lower end thereof so as to clamp the first adjusting arm and the first workpiece, wherein the first clamping jaw or the second clamping jaw of the first clamper is slidably secured in the first sliding slot of the first adjusting arm;
a second clamper including a third clamping jaw mounted on an end portion of a third lower end thereof and a fourth clamping jaw fixed on an end portion of a fourth lower end thereof so as to clamp the second adjusting arm and the second workpiece, wherein the third clamping jaw or the fourth clamping jaw of the second clamper is slidably secured in the second sliding slot of the second adjusting arm.

3. The adjustable positioning fixture as claimed in claim 2, wherein the first sliding slot of the first adjusting arm has a first shoulder, the second sliding slot of the second adjusting arm has a second shoulder.

4. The adjustable positioning fixture as claimed in claim 2, wherein the first clamping jaw of the first clamper is slidably secured in the first sliding slot of the first adjusting arm.

5. The adjustable positioning fixture as claimed in claim 2, wherein the third clamping jaw of the second clamper is slidably secured in the second sliding slot of the second adjusting arm.

6. The adjustable positioning fixture as claimed in claim 1, wherein the rotatable fixing structure includes a first connecting segment mounted on an end portion of the first adjusting arm, a second connecting segment mounted on an end portion of the second adjusting arm, a bolt element inserted through the first connecting segment of the first adjusting arm and the second connecting segment of the second adjusting arm, and a screwing element for screwing with the threaded extension of the bolt element.

7. The adjustable positioning fixture as claimed in claim 2, wherein the rotatable fixing structure includes a first connecting segment mounted on an end portion of the first adjusting arm, a second connecting segment mounted on an end portion of the second adjusting arm, a bolt element inserted through the first connecting segment of the first adjusting arm and the second connecting segment of the second adjusting arm, and a screwing element for screwing with the threaded extension of the bolt element.

8. The adjustable positioning fixture as claimed in claim 6, wherein the first connecting segment of the first adjusting arm has a first hole, and the second connecting segment of the second adjusting arm has a second hole.

9. The adjustable positioning fixture as claimed in claim 6, wherein the bolt element has a threaded extension, and the screwing element has inner threads.

10. The adjustable positioning fixture as claimed in claim 6, wherein a graduation indicator is arranged on the first connecting segment of the first adjusting arm so as to view the rotating angle between the first adjusting arm and the second adjusting arm.

11. The adjustable positioning fixture as claimed in claim 6, wherein the first adjusting arm is fixed on the second connecting segment of the second adjusting arm.
